(19) United States
(12) Patent Application Publication
(10) Pub. No.: US 2017/0074118 A1
(43) Pub. Date: Mar. 16, 2017

(54) SHIM ASSEMBLY FOR TURBOMACHINE

(71) Applicants: Michael Todd SUMMERS, Greenville, SC (US); Julian GRZYMKOWSKI, Warsaw (PL); General Electric Company, Schenectady, NY (US)

(72) Inventors: Michael Todd SUMMERS, Greenville, SC (US); Julian GRZYMKOWSKI, Warsaw (PL)

(21) Appl. No.: 15/123,345

(22) PCT Filed: Apr. 11, 2014
(86) PCT No.: PCT/PL2014/050019

§ 371 Date: Sep. 2, 2016

(51) Int. Cl. F01D 25/16; F16B 37/04; F16B 33/02; F01D 25/28; F01D 25/30

(52) U.S. Cl. CPC F01D 25/162; F01D 25/28; F01D 25/30; F16B 33/02; F16B 37/047

(57) ABSTRACT

A shim assembly includes a shim having a first side and a second side, at least one of the first side and the second side being oriented to form a wedge-shaped shim. Also included is a threaded fastener operatively coupled to the shim and configured to translate the shim in a direction parallel to a longitudinal direction of the threaded fastener.

### BACKGROUND OF THE INVENTION

The subject matter disclosed herein relates to a shim assembly used to fill small gaps or spaces in turbomachine assemblies, such as those in exhaust frames of gas turbine engines.

Alignment of components located in close proximity to each other is challenged by design and manufacturing tolerances. In an effort to properly align adjacent components and to improve load transfer between the components, a shim or other component is often employed to close a space therebetween. The use of shims to close such spaces requires precise shim grinding, typically over multiple iterations that necessitates increased labor hours, and hence overall cost.

### BRIEF DESCRIPTION OF THE INVENTION

According to one aspect of the invention, a shim assembly includes a shim having a first side and a second side, at least one of the first side and the second side being oriented to form a wedge-shaped shim. Also included is a threaded fastener operatively coupled to the shim and configured to translate the shim in a direction parallel to a longitudinal direction of the threaded fastener.

According to another aspect of the invention, an exhaust frame assembly for a gas turbine engine includes an exhaust frame structure. Also included is a bearing housing operatively coupled to the exhaust frame structure, the bearing housing having an housing surface positioned in close proximity to a support structure surface of the exhaust frame structure. Further included is a shim assembly disposed between the bearing housing and the exhaust frame structure. The shim assembly includes a shim extending from a first end to a second end in a shim longitudinal direction along the housing surface of the bearing housing, the shim having a first side that is oriented to substantially correspond to the housing surface of the bearing housing and a second side configured to abut the support structure surface of the exhaust frame structure. The shim assembly also includes a barrel nut disposed in an opening of the shim, the opening extending in a direction from the first side to the second side. The shim assembly further includes a threaded fastener operatively coupled to the shim with a threaded connection between the threaded fastener and the barrel nut, the threaded fastener configured to translate the shim in a direction parallel to a longitudinal direction of the threaded fastener.

According to yet another aspect of the invention, a gas turbine assembly includes a compressor section, a combustion section, and a turbine section. Also included is an exhaust frame located at a downstream end of the turbine section, the exhaust frame having a bearing housing operatively coupled to the exhaust frame, the bearing housing having a first housing surface positioned in close proximity to a first support structure surface of the exhaust frame. Further included is a first shim assembly disposed between the bearing housing and the exhaust frame. The first shim assembly includes a first shim extending from a first end to a second end in a shim longitudinal direction along the first housing surface of the bearing housing, the first shim having a first side that is oriented to substantially correspond to the first housing surface of the bearing housing and a second side configured to abut the first support structure surface of the exhaust frame. The first shim assembly also includes a first barrel nut disposed in a first opening of the first shim, the first opening extending in a direction from the first side to the second side. The first shim assembly further includes a first threaded fastener operatively coupled to the first shim with a threaded connection between the first threaded fastener and the first barrel nut, the first threaded fastener configured to translate the first shim in a direction parallel to a longitudinal direction of the first threaded fastener.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is an aft, elevational view of an exhaust frame of the gas turbine engine;

FIG. 3 is an enlarged view of Section III of FIG. 2 illustrating a portion of a bearing housing operatively coupled to the exhaust frame;

FIG. 4 is a perspective view of a shim assembly in association with the bearing housing;

FIG. 5 is an enlarged perspective view of the shim assembly according to Section V of FIG. 4;

FIG. 6 is a side elevational view of the shim assembly;

FIG. 7 is a side view of a threaded fastener of the shim assembly;

FIG. 8 is an end view of the shim assembly disposed between the bearing housing and a support structure with a portion of the shim assembly transparently shown;

FIG. 9 is an end view of the shim assembly disposed in a first position; and

FIG. 10 is an end view of the shim assembly disposed in a second position.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system.

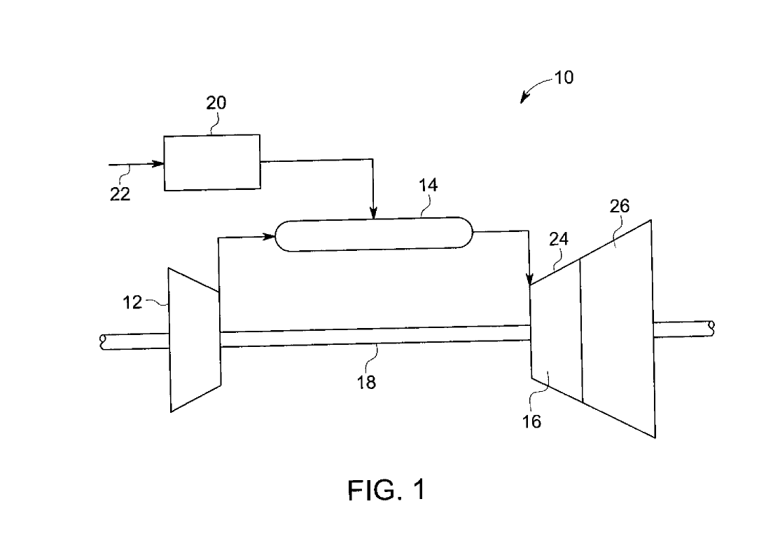

Referring to FIG. 1, a turbine system, such as a gas turbine engine, for example, is schematically illustrated and generally referred to with reference numeral 10. The gas turbine engine 10 includes a compressor section 12, a combustor section 14, a turbine section 16, a shaft 18 and a fuel nozzle 20. It is to be appreciated that one embodiment of the gas turbine engine 10 may include a plurality of compressors 12, combustors 14, turbines 16, shafts 18 and fuel nozzles 20. The compressor section 12 and the turbine section 16 are coupled by the shaft 18. The shaft 18 may be a single shaft or a plurality of shaft segments coupled together to form the shaft 18.

The combustor section 14 uses a combustible liquid and/or gas fuel, such as natural gas or a hydrogen rich synthetic gas, to run the gas turbine engine 10. For example, fuel nozzles 20 are in fluid communication with an air supply and a fuel supply 22. The fuel nozzles 20 create an air-fuel mixture, and discharge the air-fuel mixture into the combustor section 14, thereby causing a combustion that creates a hot pressurized exhaust gas. The combustor section 14 directs the hot pressurized gas through a transition piece into a turbine nozzle (or “stage one nozzle”), and other stages of buckets and nozzles causing rotation of turbine blades within an outer casing 24 of the turbine section 16. Subsequently, the hot pressurized gas is sent from the turbine section 16 to an exhaust assembly 26 that is operably coupled to a portion of the turbine section, such as the outer casing 24, for example.

Although illustrated and described above as the gas turbine engine 10, it is to be appreciated that the embodiments described herein may be applicable to any turbine system, such as a steam turbine, or any components associated therewith.

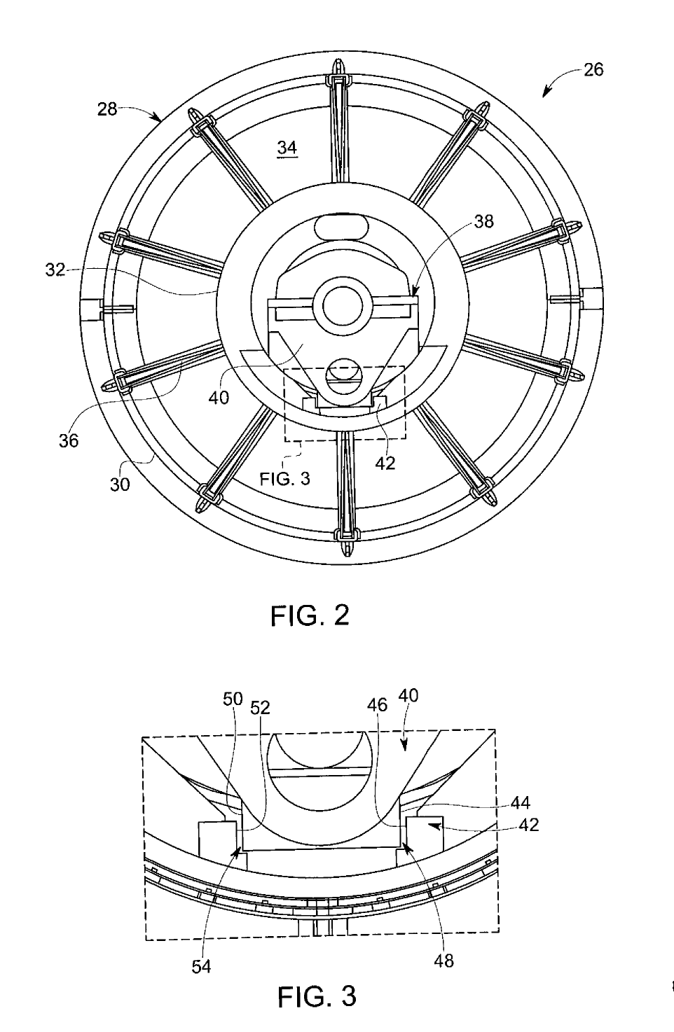

Referring to FIG. 2, an exhaust frame 28 that is part of the exhaust assembly 26 is shown from an aft end of the exhaust frame 28. In other words, the exhaust frame 28 is seen in a downstream-to-upstream view. The exhaust frame 28 includes an outer barrel 30 and an inner barrel 32 that define a flow path 34 for exhaust gases exiting from the turbine section 16 of the gas turbine engine 10. Extending between and operatively coupled to the outer barrel 30 and the inner barrel 32 is a plurality of struts 36 that provide structural stability for the inner barrel 32. The inner barrel 32 is configured to allow the shaft 18 (i.e., rotor) to pass therethrough. To facilitate confined rotation of the shaft 18, a bearing assembly 38 is disposed in the inner barrel 32. A bearing housing 40 is operatively coupled to, and at least partially supported by a support structure 42 of the exhaust frame 28.

FIG. 3 illustrates an enlarged view of a portion of FIG. 2 to show a portion of the bearing housing 40 in close proximity to the support structure 42. More specifically, a first housing surface 44 is in close proximity to a first support structure surface 46, with a first space 48 therebetween. Similarly, a second housing surface 50 is in close proximity to a second support structure surface 52, with a second space 54 therebetween.

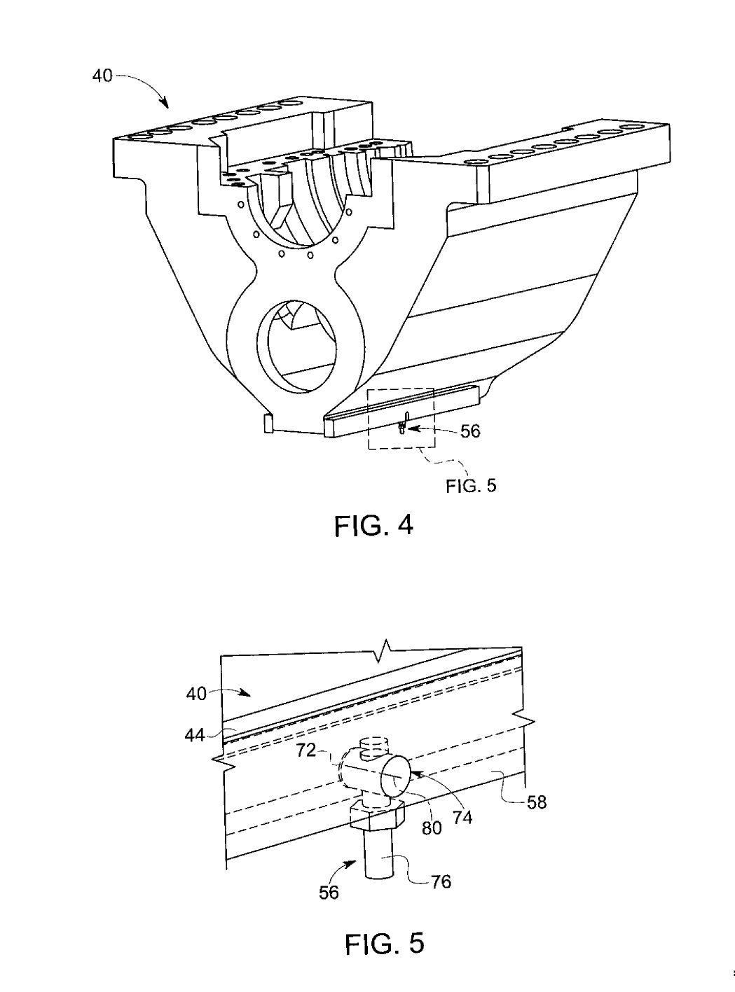

Referring to FIG. 4, the bearing housing 40 is illustrated in a perspective view. A shim assembly 56 is provided to close the first space 48 to provide better alignment and load transfer between the bearing housing 40 and the support structure 42. The shim assembly 56 is shown in contact with the first housing surface 44 in an elongated manner. As shown, a second shim assembly may be included on the second housing surface 50 to close the second space 54 present between the second housing surface 50 and the second support structure surface 52. For purposes of discussion, a single shim assembly will be described in detail below, but it is to be appreciated that two shim assemblies on each side of the bearing housing 40 will be employed in many instances.

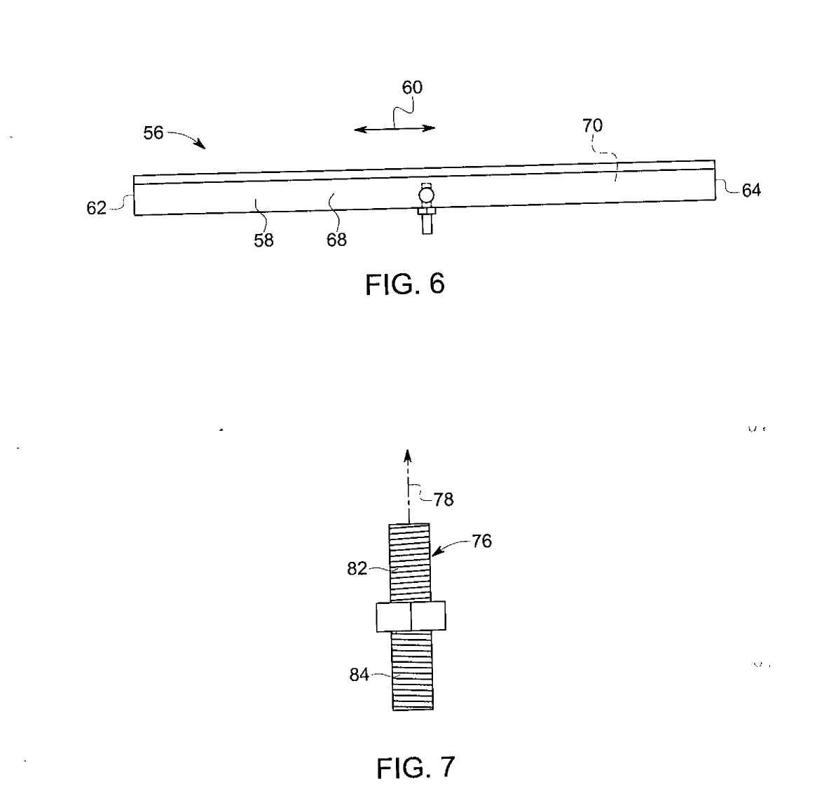

Referring to FIGS. 5-7, the shim assembly 56 is illustrated in greater detail. The shim assembly 56 includes a shim 58 that extends in a shim longitudinal direction 60 from a first end 62 to a second end 64. The shim 58 also includes a first side 68 and a second side 70. The first side 68 is configured to engage the first housing surface 44 and the second side 70 is configured to engage the first support structure surface 46. The first side 68 and the second side 70 are substantially oriented to correspond to the respective surfaces to which they engage. Although it is contemplated that both the first side 68 and the second side 70 may be oriented parallel to each other in a substantially orthogonal direction to that of the shim longitudinal direction 60, typically at least one of the first side 68 and the second side 70 is angled to form a wedge-shaped shim. Such a geometry facilitates a more reliable and convenient insertion of the shim 58 into the first space 48.

An opening 72 is formed in the shim 58 and extends in a direction extending between the first side 68 and the second side 70. The opening 72 may be a hole extending fully through the shim 58 or a recess that extends only partially through the shim 58. In the case of a recess, the opening may be formed in the first side 68 or the second side 70. Irrespective of the precise structure, the opening 72 is located in a substantially centered position of the shim 58. In particular, the opening 72 is typically located along the shim longitudinal direction 60 at a position that is relatively equidistant between the first end 62 and the second end 64 of the shim 58.

Disposed within the opening 72 is a barrel nut 74 having an internal threaded region configured to receive and form a threaded connection with a threaded fastener 76. The threaded fastener 76 is operatively coupled to the shim 58 via the threaded connection between the threaded fastener 76 and the barrel nut 74. The threaded fastener 76 is configured to translate the shim 58 in a direction parallel to a longitudinal direction 78 of the threaded fastener 76.

In operation, as the shim 58 is translated due to the rotation of the threaded fastener 76, the first space 48 is reduced. The threaded fastener 76 is rotated until the shim 58 translates to achieve a desired clearance with the bearing housing 40 and/or the support structure 42. Alternatively, all or a portion of the first side 68 and/or the second side 70 of the shim 58 comes into contact with the first housing surface 44 and the first support structure surface 46. Upon contacting the bearing housing 40 and/or the support structure 42, the shim 58 is configured to rotate in a pivotal manner about an axis 80 of the barrel nut 74 to compensate for misalignment or lack of parallelism between the shimmed surfaces.

As shown best in FIG. 7, the threaded fastener 76 includes a first threaded portion 82 and a second threaded portion 84. The hand or helical direction of the thread defined by the first threaded portion 82 of the threaded fastener 76 is opposite to the hand or helical direction of the thread defined by the second threaded portion 84 of the threaded fastener 76. Thus, for example, if the thread defined by the first threaded portion 82 is a left-hand thread (i.e., a thread that advances helically in a clockwise direction as it advances axially along the shank away from the head), then the thread defined by the second threaded portion 84 can be a right-hand thread (i.e., a thread that advances helically in a counter-clockwise direction as it advances axially along the shank away from the head). Alternatively, if the thread defined by the first threaded portion 82 is a right-hand thread, then the thread defined by the second threaded portion 84 can be a left-hand thread. The pitches of the first threaded portion 82 and second threaded portion 84 can be the same or different from one another, as desired. Such a configuration facilitates translation of the shim 58 that the threaded fastener 76 is operatively coupled to, while maintaining the relative position of the support structure 42 that the threaded fastener 76 is also associated with.

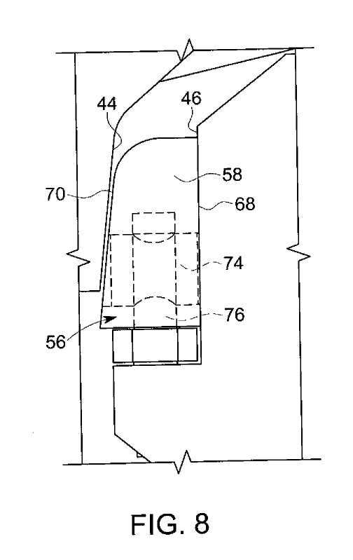

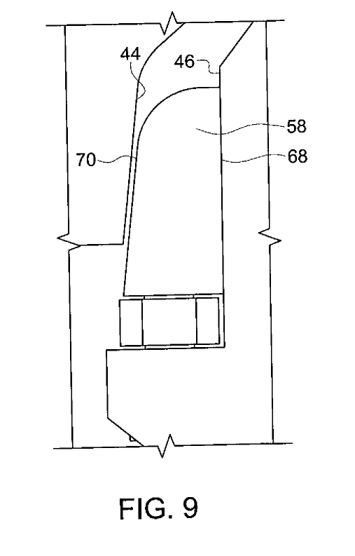

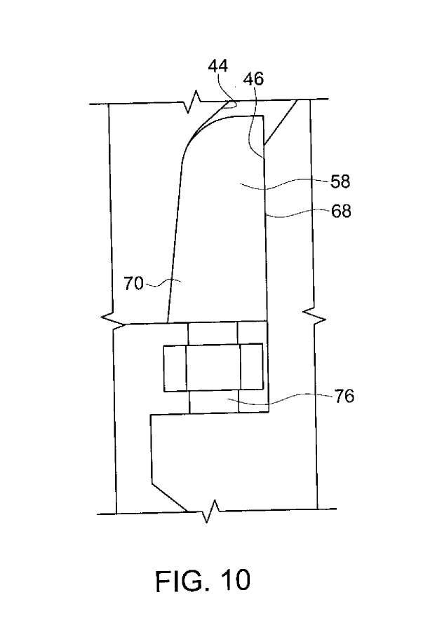

FIGS. 8-10 illustrate the shim assembly 56 in multiple conditions. In one condition (FIGS. 8 and 9), the shim assembly 56 is disposed within the first space 48, with a small clearance between the first side 68 of the shim 58 and the first housing surface 44. In certain applications, such a small clearance may be desirable. In another condition (FIG. 10), the shim assembly 56 is translated further into the first space 48 to form contact between the first side 68 of the shim 58 and the first housing surface 44. The precise amount of translation of the shim assembly 56 and contact or clearance between the shim 58 and the engagement surfaces will vary depending on the particular application of use.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A shim assembly comprising:
a shim having a first side and a second side, at least one of the first side and the second side being oriented to form a wedge-shaped shim; and
a threaded fastener operatively coupled to the shim and configured to translate the shim in a direction parallel to a longitudinal direction of the threaded fastener.

2. The shim assembly of claim 1, wherein the shim extends from a first end to a second end in a shim longitudinal direction.

3. The shim assembly of claim 2, further comprising a barrel nut disposed in an opening of the shim, the opening extending in a direction from the first side to the second side, wherein the threaded fastener is operatively coupled to the shim with a threaded connection between the threaded fastener and the barrel nut.

4. The shim assembly of claim 3, wherein the opening is a hole.

5. The shim assembly of claim 3, wherein the opening is a recess extending from the second side of the shim.

6. The shim assembly of claim 3, wherein the opening is located in a centered position between the first end and the second end of the shim.

7. The shim assembly of claim 6, wherein the shim is configured to twist about an axis of the barrel nut upon contact between the first side of the shim and an adjacent surface.

8. The shim assembly of claim 3, wherein the threaded fastener includes a first portion having a first thread pattern formed in a first direction and a second portion having a second thread pattern formed in a second direction that is opposite of the first direction.

9. The shim assembly of claim 1, wherein the shim assembly is disposed in a turbomachine assembly.

10. The shim assembly of claim 9, wherein the shim assembly is disposed in an exhaust frame assembly.

11. An exhaust frame assembly for a gas turbine engine comprising:
an exhaust frame structure;
a bearing housing operatively coupled to the exhaust frame structure, the bearing housing having an housing surface positioned in close proximity to a support structure surface of the exhaust frame structure; and
a shim assembly disposed between the bearing housing and the exhaust frame structure, the shim assembly comprising:
a shim extending from a first end to a second end in a shim longitudinal direction along the housing surface of the bearing housing, the shim having a first side that is oriented to substantially correspond to the housing surface of the bearing housing and a second side configured to abut the support structure surface of the exhaust frame structure;
a barrel nut disposed in an opening of the shim, the opening extending in a direction from the first side to the second side; and
a threaded fastener operatively coupled to the shim with a threaded connection between the threaded fastener and the barrel nut, the threaded fastener configured to translate the shim in a direction parallel to a longitudinal direction of the threaded fastener.

12. The exhaust frame assembly of claim 11, wherein the opening is a hole.

13. The exhaust frame assembly of claim 11, wherein the opening is a recess extending from the second side of the shim.

14. The exhaust frame assembly of claim 11, wherein the opening is located in a centered position between the first end and the second end of the shim.

15. The shim assembly of claim 14, wherein the shim is configured to twist about an axis of the barrel nut upon contact between the first side of the shim and the housing surface of the bearing housing.

16. The exhaust frame assembly of claim 11, wherein the threaded fastener includes a first portion having a first thread pattern formed in a first direction and a second portion having a second thread pattern formed in a second direction that is opposite of the first direction.

17. The exhaust frame assembly of claim 11, wherein the bearing housing includes a second housing surface configured to interact with another shim assembly.

18. A gas turbine assembly comprising:
a compressor section;
a combustion section;
a turbine section;
an exhaust frame located at a downstream end of the turbine section, the exhaust frame having a bearing housing operatively coupled to the exhaust frame, the bearing housing having a first housing surface positioned in close proximity to a first support structure surface of the exhaust frame; and
a first shim assembly disposed between the bearing housing and the exhaust frame, the first shim assembly comprising:
a first shim extending from a first end to a second end in a shim longitudinal direction along the first housing surface of the bearing housing, the first shim having a first side that is oriented to substantially correspond to the first housing surface of the bearing housing and a second side configured to abut the first support structure surface of the exhaust frame;
a first barrel nut disposed in a first opening of the first shim, the first opening extending in a direction from the first side to the second side; and
a first threaded fastener operatively coupled to the first shim with a threaded connection between the first threaded fastener and the first barrel nut, the first threaded fastener configured to translate the first shim in a direction parallel to a longitudinal direction of the first threaded fastener.

19. The gas turbine assembly of claim 18, further comprising:
a second housing surface positioned in close proximity to a second support structure surface of the exhaust frame; and
a second shim assembly disposed between the bearing housing and the exhaust frame, the second shim assembly comprising:
a second shim extending from a third end to a fourth end in the shim longitudinal direction along the second housing surface of the bearing housing, the second shim having a third side that is oriented to substantially correspond to the second housing surface of the bearing housing and a fourth side configured to abut the second support structure surface of the exhaust frame;
a second barrel nut disposed in a second opening of the second shim, the second opening extending in a direction from the third side to the fourth side; and
a second threaded fastener operatively coupled to the second shim with a threaded connection between the second threaded fastener and the second barrel nut, the second threaded fastener configured to translate the second shim in the direction parallel to the longitudinal direction of the second threaded fastener.

20. The gas turbine assembly of claim 18, wherein the opening is located in a centered position between the first end and the second end of the first shim, wherein the first shim is configured to twist about an axis of the first barrel nut upon contact between the first side of the first shim and the first housing surface of the bearing housing.
